(19) United States
(12) Patent Application Publication
(10) Pub. No.: US 2026/0046733 A1
(43) Pub. Date: Feb. 12, 2026

(54) PREFIX-INDEPENDENT CONVERGENCE OVER MOBILE USER PLANE

(71) Applicant: Arrcus Inc., San Jose, CA (US)

(72) Inventors: Keyur Patel, San Jose, CA (US); Tetsuya Murakami, San Jose, CA (US); Nalinaksh Pai, San Ramon, CA (US); Derek Man-Kit Yeung, Fremont, CA (US)

(21) Appl. No.: 19/294,051

(22) Filed: Aug. 7, 2025

Related U.S. Application Data
(60) Provisional application No. 63/681,005, filed on Aug. 8, 2024.

(51) Int. Cl. H04W 36/30; H04W 76/20; H04W 88/16

(52) U.S. Cl. CPC H04W 36/305; H04W 76/20; H04W 88/16

(57) ABSTRACT

Border gateway protocol (BGP) prefix-independent convergence is implemented over a mobile user plane (MUP). A gNodeB is dual-home with respect to multiple MUP gateways (MUP-GW). A first MUP-GW routes traffic to a second MUP-GW in response to failure of a link to the gNodeB. The first MUP-GW may determine a backup path to the second MUP-GW by resolving an ST1 route with a N3 ISD route of the second MUP-GW. The first MUP-GW may determine a backup path to the second MUP-GW by detecting that the N3 ISD route of the second MUP-GW references the address of the gNodeB. Routing may be performed using MPLS or SRv6.

### RELATED APPLICATIONS

This application claims the benefit of U.S. Provisional Application Ser. No. 63/681,005 filed Aug. 8, 2024, and entitled BGP MUP PIC Edge Patent.

### FIELD OF THE INVENTION

This application relates to implementing prefix-independent convergence (PIC) over a mobile user plane (MUP).

### BACKGROUND

The Mobile User Plane (MUP) is a protocol for routing packets received from user equipment (UE) in a cellular communication network over an internet protocol (IP) network. MUP integrates with user plane function (UPF) for managing a connection to the UE and a subscription associated with the UE with routing of packets over an IP network. It would be an advancement in the art to expand the capacity of networks to use MUP.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment connected to a cellular communication network in accordance with an embodiment of the present invention;

FIG. 2 is a table illustrating the handling of link failure using a dual-homed gNodeB and downstream multi-protocol label switching (MPLS) in accordance with an embodiment of the present invention;

FIG. 3 is a table illustrating the handling of link failure using a dual-homed gNodeB and downstream segment routing (SRv6) using N3 internetwork segment discovery (ISD) in accordance with an embodiment of the present invention;

FIG. 4 is a table illustrating the handling of link failure using a dual-homed gNodeB and downstream SRv6 using N3 and N6 ISD in accordance with an embodiment of the present invention;

FIG. 5 is a table illustrating the handling of failure of a MUP gateway using a dual-homed gNodeB and downstream MPLS in accordance with an embodiment of the present invention; and

FIG. 6 is a schematic block diagram of a computer system suitable for implementing methods in accordance with embodiments of the present invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Smalltalk, C++, or the like and conventional procedural programming languages, such as the “C” programming language or similar programming languages, and may also use descriptive or markup languages such as HTML, XML, JSON, and the like. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

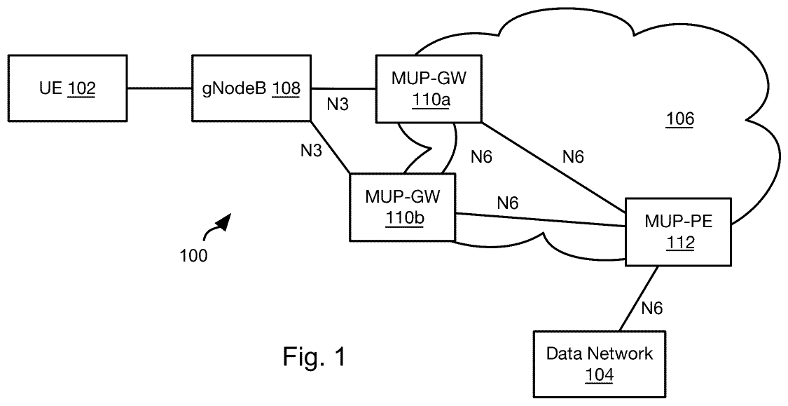

Referring to FIG. 1, the illustrated network environment 100 illustrates a connection between user equipment (UE) 102 and a data network (DN) 104, such as the Internet or other type of network, such as an internet protocol (IP) network. The UE 102 may connect to the data network 104 by way of an access network (106).

Using the approach described herein, the routing of data between the UE 102 and the data network 104 over the access network 106 is performed using mobile user plane (MUP) protocol. In particular, according to the approach described herein, MUP may be implemented over an MPLS, via segment routing (e.g., SRv6) using segment identifiers (SID), or over other type of network.

MUP may be implemented using the illustrated components, each of which has the function ascribed therein according to the MUP protocol except as explicitly noted herein. The UE 102 may connect to the access network 106 by way of a base station, such as a gNodeB 108, which performs functions of receiving packets from the UE 102 by way of a radio antenna, encapsulating the packets into general packet radio service (GPRS) tunneling protocol (GTP) packets and forwarding the GTP packets to a MUP-enabled gateway 110a (MUP-GW 110a) according to the approach described herein. The MUP-GW 110a may function as a gateway router and may be connected by the access network 106 to the data network 104 by a provider edge router 112 that is enabled to perform MUP (MUP-PE 112) according to the approach described herein.

In some embodiments, the gNodeB 108 is multi-homed with respect to multiple MUP-enabled gateways, such as MUP-GW 110a and MUP-GW 110b. MUP-GW 110b may function in the same manner as MUPG-GW 110a and provide a data path between gNodeB 108 and the MUP-PE 112. Failover between MUP-GW 110a and MUP-GW 110b may be facilitated using the methods described herein.

Routing of traffic among the illustrated components may be performed using virtual routing functions (VRF). These may include N3 and N6 VRFs. The N3 and N6 VRFs may be as defined according to any approach for implementing MUP known in the art. In the illustrated embodiment, the N3 VRF is a virtual routing function defining the routing of traffic between the gNodeB 108 and one or more MUP-GWs, such as the MUP-GWs 110a, 110b. Routing of traffic among the MUP-GWs 110a, 110b and the MUP-PE 112, may be defined by the N6 VRF. The configuration of the N3 and N6 VRF may be managed by a MUP-C(not shown).

In cellular data communication networks that do not use MUP, the gNodeB 108 would transmit GTP packets to a user plane function (UPF) associated with a gateway. The UPF would then decapsulate the packets from GTP packets to IP packets and forward the IP packets to a gateway. MUP provides an improved approach that enables data packets to be transmitted to a gateway in bypass the UPF.

Failures in cellular data communication networks may be mitigated using border gateway protocol (BGP) prefix-independent convergence (PIC). BGP PIC reduces traffic loss during network topology changes. BGP PIC maintains a precomputed backup path which has a different next hop than a corresponding primary path. Switches from the primary path using network hardware upon network failure detection. The convergence time of BGP PIC is independent of the number of BGP prefixes sharing the same next hop. BGP PIC supports address families such as IPv4, IPv6 and level three virtual private network (L3VPN), and the like.

MUP is a new address family that has different route types and defines dependency among them. For example, a type 1 session transformed route (ST1) and internetwork segment discovery (ISD) routes, which are dependent on one another, and a type 2 session transformed route (ST2) route and direct segment discovery (DSD) routes, that are likewise dependent on one another.

The methods disclosed herein enable implementation of a BGP PIC edge using MUP for access networks 106 implemented using SRv6 or MPLS in various scenarios. Other types of routing protocols may also be used to implement the access networks 106.

In the approaches described herein, gNodeB 108 may be multi-homed with respect to multiple MUP-GWs 110a, 110b. Each MUP-GW may advertise one or more ISD routes. For example, some or all of the following use cases may be implemented:
1. Each MUP-GW 110a, 110b advertises N3 ISD carrying MPLS label for N3 VRF and N6 ISD carrying MPLS label for N6 VRF.
2a. Each MUP-GW 110a, 110b advertises an N3 ISD carrying SRv6 GTP4/6.E SID (an SID defining GTP encapsulation per an IPv4 or IPv6 table lookup table; also known as End.M.GTP4.E or End.M.GTP6.E per RFC9433) for N3 VRF.
2b. Each MUP-GW 110a, 110b may advertise an N6 ISD carrying one or more SRv6 DT4/6 SIDs (an SID defining decapsulation per an IPv4 or IPv6 lookup table; also known as End.DT4, End.DT6, or End.DT46) for N6 VRF.
2c. Each MUP-GW 110a, 110b may advertise N6 ISD carrying one or more SRv6 DX4/6 SIDs (an SID defining cross-connect behavior that can provide a next hop directly rather than doing a look up to find an outgoing next hop; also known as End.DX4 or End.DX6).
3. Each MUP-GW 110a, 110b advertises N3 ISD carrying SRv6 GTP4/6.E SID for N3 VRF.

The ST1 route may be resolved with the ISD route through endpoint lookup on the MUP-PE 112 and possibly the MUP-GWs 110a, 110b. The ST1 route provides reachability to UEs 102 and therefore may be used to realize downstream traffic from the data networks 104 to UEs 102.

The ST2 route may be combined with DSD through MUP Extcomm matching on one or both of the MUP-GWs 110a, 110b. The ST2 route may provide tunnel-termination for GTP encapsulated packets and to realize upstream traffic from UEs 102 to data networks 104.

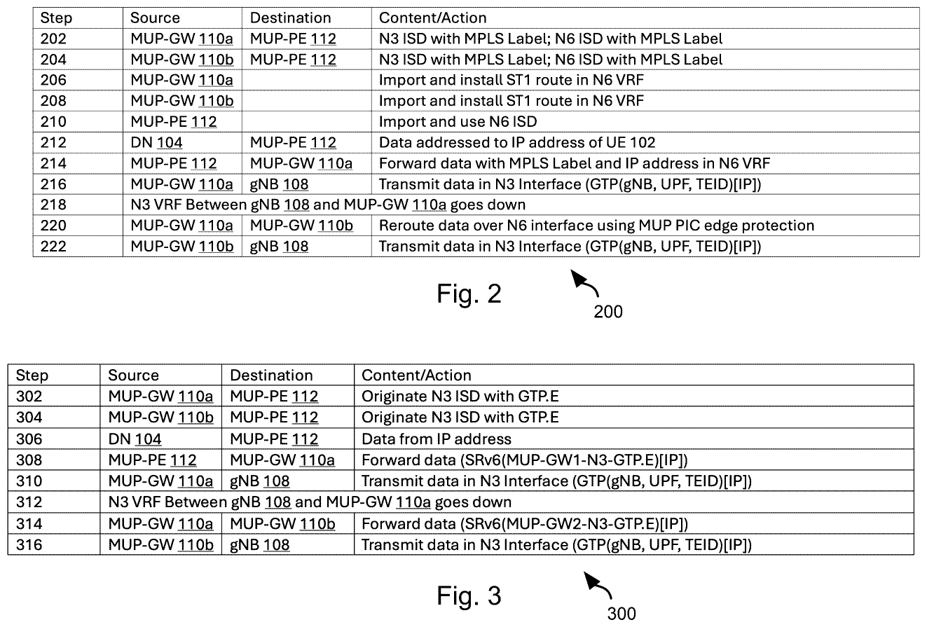

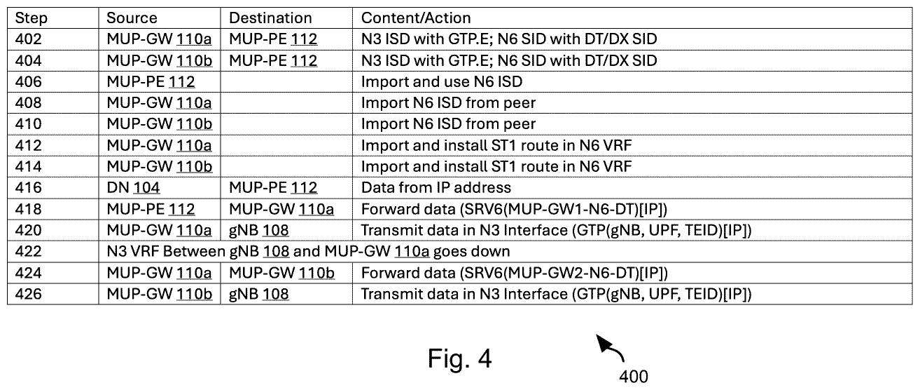

BGP PIC using MUP may include installing of MUP-GW routes. For example, the MUP-GWs 110a, 110b may install their corresponding ST1 route. ISD routes may carry an MPLS label (see FIG. 2 and corresponding description) or the DT/DX SIDs defining decapsulation and routing per a lookup in a VPN routing table (DT) and decapsulation performing routing according to a next hop interface (DX) (see FIG. 4 and corresponding description. A best path may be calculated by resolving ST1 of an MUP-GW 110a, 110b with the local N3 ISD of that MUP-GW 110a, 110b. A backup path for BGP PIC may be calculated by resolving the same ST1 with a peer MUP-GW N3 or N6 ISD (e.g., resolve the ST1 of MUP-GW 110a with the ISD of MUP-GW 110b, or vice versa).

In another example, the MUP-GWs 110a, 110b do not install an ST1 route. The ISD may carry a GTP.E SID. The best path may be calculated by a MUP-GW 110a, 110b by combining the local (e.g., advertised by the same MUP-GW 110a, 110b) N3 ISD GTP.E SID with N3 VRF information (see FIG. 4 and corresponding description). The backup path may calculated by detecting that the N3 ISD from a peer MUP-GW references the same gNodeB prefix of the gNodeB 108 (e.g., backup path for MUP-GW 110a determined by detecting from the N3 ISD of MUP-GW 110b that MUP-GW 110b is connected to the same gNodeB 108 as MUP-GW 110a, i.e., gNodeB 108 that is dual-homed with respect to MUP-GWs 110a, 110b). The first and second uses cases could be enabled at the same time on the same MUP-GW 110a, 110b.

Failover may occur in response to a PIC edge trigger. For example, MUP-GW 110a may detect that the connectivity (link or route) from the MUP-GW 110a towards the gNodeB 108 is down and switch the route from the best to the backup within 50 ms. In this manner, connectivity to the backup path is achieved before routing protocol convergence which could take seconds or tens of seconds.

Referring to FIG. 2, the illustrated method 200 may be used to implement BGP PIC for a dual-homed gNodeB 108 where the access network 106 is implemented using MPLS. In the method 200 and other methods described herein, the MUP GW 110a is in a primary (“best”) path between the MUP-PE 112 and the gNodeB 108 and the MUP GW 110b is in the backup path between the MUP-PE 112 and the gNodeB 108.

At step 202, MUP GW 110a originates a N3 ISD with an MPLS label and a N6 ISD with an MPLS label. At step 204, MUP GW 110b also originates a N3 ISD with an MPLS label and a N6 ISD with an MPLS label. The N6 ISDs from MUP-GWs 110a, 110b may be received by the MUP-PE 112. At steps 206 and 208, the MUP-GWs 110a, 110b import and install the ST1 route in the N6 VRF, which may include installing the ST1 route into the N6 ISDs, e.g., MUP-GW 110a installs the ST1 route of MUP-GW 110b into the N6 ISD of MUP-GW 110a and MUP-GW 110b installs the ST1 route of MUP-GW 110a into the N6 ISD of MUP-GW 110b. On each MUP-GW 110a, 110b, the installation of the best ST1 routes uses the local N3 ISD route (e.g., the N3 ISD route advertised by the MUP-GW 110a, 110b installing the ST1 route). Both MUP-GW 110a, 110b may also import each other's N6 ISD. The installation of the backup ST1 routes make use of the imported N6 ISD. The approach follows the rule in MUP that ST1 is dependent on the ISD. At step 210, the MUP PE 112 imports and uses the N6 ISD of MUP-GW 110a as a best path to the gNodeB 108. Note that because MUP PE 112 imports the N6 ISDs from both MUP-GWs 110a, 110b, both may be used per ECMP or one may be used as the best path with the other providing a backup path when the best path is not available. The MUP PE 112 may also import and install ST1 routes (dependent on the N6 ISD). In this manner, the MUP-PE 112 receives the route to forward traffic towards the UE 102 through one of the MUP GWs 110a, 110b.

At step 210, the MUP PE 112 may also import and use the N6 ISD of MUP-GW 110b, such as to pre-calculate a backup path to the gNodeB 108. There are two paths available through the two MUP-GWs 110a, 110b for downstream traffic from the data network 104 to reach the UE 102. The MUP-GW 110a is the primary exit from the access network 106. The MUP-GWs 110a, 110b may remain in an active standby setup, such as a non-ECMP (equal cost multi-path (ECMP)) active standby setup.

At step 212, an endpoint in the data network 104 may transmit data to the UE 102, e.g., an IP address of the UE 102. The data is received by the MUP-PE 112. At step 214, the MUP-PE 112 forwards the data to the MUP-GW 110a in the N6 VRF, the data being labeled with the MPLS label of the ISD from step 202. At step 216, MUP-GW 110a transmits the data in the N3 interface to the gNodeB 108. The data may be encapsulated into a GTP packet including the address of the gNodeB 108 (“gNB”), a UPF identifier, and tunnel endpoint identifier (TEID), as well as the IP address of the UE 102.

Steps 212-216 may be performed repeatedly during duration of communication between the UE 102 and the endpoint in the data network 104. At some point (step 218), the N3 VRF between MUP-GW 110a and the gNodeB 108 may go down. Subsequent steps of the method 200 may be performed in response to failure of the N3 VRF between MUP-GW 110a and the gNodeB 108.

At step 220, the MUP-GW 110a may reroute data received at an iteration of step 214 to over the N6 interface to MUP-GW 110b using MUP PIC edge protection, e.g., using the ST1 route imported into the N6 VRF at step 206. MUP-GW 110b receives the rerouted data. At step 222, MUP-GW 110b transmits the data in the N3 interface to the gNodeB 108. The data may be encapsulated into a GTP packet including the address of the gNodeB 108 (“gNB”), a UPF identifier, and tunnel endpoint identifier (TEID), as well as the IP address of the UE 102.

In the absence of MUP PIC edge protection, traffic from the MUP-PE 112 would be dropped until the MUP-PE converges on a path through the MUP-GW 110b to exit the access network 106. With MUP PIC edge link protection, MUP-GW 110a reroutes the packet to MUP-GW 110b and reduces dropped traffic. Note that an Active-Active setup (ECMP setup) is possible in which both of the MUP-GWs 110a, 110b are active. In such a scenario, rerouting of packets in response to failure of a link of one MUP-GW 110a, 110b to gNodeB 108 to the other of the MUP GW 110b, 110a may be performed in a like manner.

In some implementations, the gNodeB 108 is multi-homed to multiple MUP-GWs110a, 110b. Each MUP-GW 110a, 110b installs ST1 routes. Each MUP-GW 110a, 110b may advertise two ISD routes. The first may be a N3 ISD route used by the MUP-GW 110a, 110b itself for ST1 resolution to provide reachability to the UE 102 through the gNodeB 108. The MPLS label is not relevant to this N3 ISD route in some embodiments. One of the N3 ISD routes may be a best path and the other may be the backup path. The second of the ST1 routes may be an N6 ISD route. For example, the local N3 ISD (e.g., local to the MUP-GW 110a, 110b installing the ST1 route) is used to resolve the ST1 routes to provide the best path. The N6 ISD from the peer MUP-GW 110a, 110b (other than the MUP-GW 110a, 110b installing the ST1 route) is used to resolve ST1 routes to provide the backup path.

The N6 ISD route may include a per-VRF MPLS label or per-next hop label. The N6 ISD route may be used by the peer MUP-GW 110a, 110b to route packet to the local MUP-GW 110b, 110a upon link failure and to implement a backup path. The N6 ISD routes may be used by the MUP-PE 112 for resolving ST1 to provide UE reachabilities through the MUP-GWs 110a, 110b.

Referring to FIG. 3, the illustrated method 300 may be used to implement BGP PIC for a dual-homed gNodeB 108 where the access network 106 is implemented using SRv6. At step 302, MUP-GW 110a originates an N3 ISD with a GTP.E segment identifier (SID), which may be received by the MUP-PE 112. At step 304, MUP-GW 110b originates an N3 ISD with a GTP.E SID, which may also be received by the MUP-PE 112. In some implementations of the method 300, the MUP-GWs 110a, 110b do not import or install ST1 routes. There are two paths available through the two MUP-GWs 110a, 110b for downstream traffic from the data network 104 to reach the UE 102. The MUP-GW 110a is the primary exit from the access network 106. The MUP-GWs 110a, 110b may remain in an active standby setup, such as a non-ECMP active standby setup. In the use cases described herein with respect to FIGS. 2, 3, and 4, the MUP PE 112 may always import and install the ST1 routes. However, the use cases differ with respect to which ISD is used to resolve the ST1 dependence. In the use case of FIG. 3, the MUP-ME 112 will import the N3 ISDs from the MUP-GWs 110a, 110b and these N3 ISDs will be used when installing ST1 routes.

At step 306, an endpoint in the data network 104 may transmit data to the UE 102, e.g., an IP address of the UE 102. The data is received by the MUP-PE 112. At step 308, the MUP-PE 112 forwards the data to the MUP-GW 110a in the N6 VRF, the data being labeled with the GTP.E SID corresponding to the ISD route of MUP-GW 110a (GW1 in FIG. 3), e.g., MUP-GW1-N3-GTP.E. At step 310, MUP-GW 110a transmits the data in the N3 interface to the gNodeB 108. The data may be encapsulated into a GTP packet including the address of the gNodeB 108 (“gNB”), a UPF identifier, and tunnel endpoint identifier (TEID), as well as the IP address of the UE 102.

Steps 306-310 may be performed repeatedly during duration of communication between the UE 102 and the endpoint in the data network 104. At some point (step 312), the N3 interface (in the N3 VRF) between MUP-GW 110a and the gNodeB 108 may go down. Subsequent steps of the method 300 may be performed in response to failure of the N3 VRF between MUP-GW 110a and the gNodeB 108.

At step 314, the MUP-GW 110a may reroute data received at an iteration of step 308 to over the N6 interface to MUP-GW 110b using MUP PIC edge protection. Rerouting the data may include labeling the data with the GTP.E SID corresponding to MUP-GW 110b (MUP-GW2-N3-GTP.E, where GW2 refers to MUP-GW 110b). Arguments such as mobile session and gNodeB 108 address may remain the same as for data as encapsulated by the MUP-PE 112 and transmitted to the MUP-GW 110a. MUP-GW 110b receives the rerouted data. At step 316, MUP-GW 110b transmits the data in the N3 interface to the gNodeB 108. The data may be encapsulated into a GTP packet including the address of the gNodeB 108 (“gNB”), a UPF identifier, and tunnel endpoint identifier (TEID), as well as the IP address of the UE 102.

In the absence of MUP PIC edge protection, traffic from the MUP-PE 112 would be dropped until the MUP-PE converges on a path through the MUP-GW 110b to exit the access network 106. With MUP PIC edge link protection, MUP-GW 110a reroutes the packet to MUP-GW 110b and reduces dropped traffic. Note that an Active-Active setup (ECMP setup) is possible in which both of the MUP-GWs 110a, 110b are active. In such a scenario, rerouting of packets in response to failure of a link of one MUP-GW 110a, 110b to gNodeB 108 to the other of the MUP GW 110b, 110a may be performed in a like manner.

In the method 300, gNodeB 108 is multi-homed to multiple MUP-GWs 110a, 110b. Each MUP-GW 110a, 110b may refrain from installing ST1 routes. Each MUP-GW may advertise only one N3 ISD. The N3 ISD may carry a GTP.E SID. The N3 ISD may be used by the local MUP-GW (e.g., whichever of MUP-GW 110a, 110b advertised the N3 ISD) to encapsulate inner IP packets into GTP packets that are forwarded over the N3 interface to the gNodeB 108.

The N3 ISD forwarded by a MUP-GW may be used by a peer MUP-GW (e.g., whichever of MUP-GW 110b, 110a did not advertise the N3 ISD) to route packets to the local MUP-GW upon link failure. The N3 ISD may be identified as having the same gNodeB prefix as the N3 ISD that is local the peer MUP-GW. The peer MUP-GW may therefore use the N3 ISD as a backup path. The N3 ISD may be used by the MUP-PE 112 to resolve the ST1 route to provide UE reachabilities through whichever of the MUP-GWs 110a, 110b is in the active path (best path or backup path upon link failure).

Referring to FIG. 4, the illustrated method 400 may be used to implement BGP PIC for a dual-homed gNodeB 108 where the access network 106 is implemented using SRv6 and the N6 ISD. At step 402, MUP-GW 110a originates an N3 ISD with GTP.E, which may be received by the MUP-PE 112. Step 402 may further include originating an N6 SID with a DT/DX SID, which may be received by the MUP-PE 112. At step 404, MUP-GW 110b originates an N3 ISD with GTP.E, which may be received by the MUP-PE 112. Step 404 may further include originating an N6 SID with a DT/DX SID, which may be received by the MUP-PE 112. At step 406, the MUP-PE 112 may import and use the N6 ISD routes.

At step 408, the MUP-GW 110a imports the N6 ISD route of its peer (MUP-GW 110b). At step 410, the MUP-GW 110b imports the N6 ISD route of its peer (MUP-GW 110a). At steps 412, 414, the MUP-GWs 110a, 110b import and install the ST1 route in the N6 VRF.

There are two paths available through the two MUP-GWs 110a, 110b for downstream traffic from the data network 104 to reach the UE 102. The MUP-GW 110a is the primary exit from the access network 106. The MUP-GWs 110a, 110b may remain in an active standby setup, such as a non-ECMP active standby setup.

At step 416, an endpoint in the data network 104 may transmit data to the UE 102, e.g., an IP address of the UE 102. The data is received by the MUP-PE 112. At step 418, the MUP-PE 112 forwards the data to the MUP-GW 110a in the N6 VRF, the data being labeled with an SRv6 SID corresponding to the N6 ISD route of MUP-GW 110a (GW1 in FIG. 4), e.g., MUP-GW1-N6-DT. At step 420, MUP-GW 110a transmits the data in the N3 interface to the gNodeB 108. The data may be encapsulated into a GTP packet including the address of the gNodeB 108 (“gNB”), a UPF identifier, and tunnel endpoint identifier (TEID), as well as the IP address of the UE 102.

Steps 416-420 may be performed repeatedly during duration of communication between the UE 102 and the endpoint in the data network 104. At some point (step 422), the N3 VRF between MUP-GW 110a and the gNodeB 108 may go down. Subsequent steps of the method 400 may be performed in response to failure of the N3 VRF between MUP-GW 110a and the gNodeB 108.

At step 424, the MUP-GW 110a may reroute data received at an iteration of step 418 to over the N6 interface to MUP-GW 110b using MUP PIC edge protection. Rerouting the data may include labeling the data with an SID corresponding to MUP-GW 110b (MUP-GW2-N6-DT, where GW2 refers to MUP-GW 110b). MUP-GW 110b receives the rerouted data. At step 426, MUP-GW 110b transmits the data in the N3 interface to the gNodeB 108. The data may be encapsulated into a GTP packet including the address of the gNodeB 108 (“gNB”), a UPF identifier, and tunnel endpoint identifier (TEID), as well as the IP address of the UE 102. In some embodiments, MUP GW 110a may use the N3 ISD of MUP-GW 110b to reroute traffic at step 424, e.g., using the SID MUP-GW2-N3-GTP.E advertised at step 404.

In the absence of MUP PIC edge protection, traffic from the MUP-PE 112 would be dropped until the MUP-PE converges on a path through the MUP-GW 110b to exit the access network 106. With MUP PIC edge link protection, MUP-GW 110a reroutes the packet to MUP-GW 110b and reduces dropped traffic. Note that an Active-Active setup (ECMP setup) is possible in which both of the MUP-GWs 110a, 110b are active. In such a scenario, rerouting of packets in response to failure of a link of one MUP-GW 110a, 110b to gNodeB 108 to the other of the MUP GW 110b, 110a may be performed in a like manner.

In the method 400, gNodeB 108 is multi-homed to multiple MUP-GWs 110a, 110b. Each MUP-GW 110a, 110b may install ST1 routes. Each MUP-GW 110a, 110b may advertise two ISDs: the N3 ISD and the N6 ISD. The N3 ISD by the MUP GW 110a, 110b that advertised it for ST1 resolution to provide reachabilities through the gNodeB 108. The N3 ISD may include a GTP encapsulation (GTP.E) SID and may indicate whether the N3 ISD is the best path (e.g., the N3 ISD of MUP-110a in the illustrated example). The N6 SID may include the DT SID may be used by a peer MUP-GW (e.g., whichever of MUP-GW 110b, 110a did not advertise the N6 ISD) to route packets to the local MUP-GW (whichever of MUP-GW 110b, 110a advertised the N6 ISD) upon link failure. The N6 ISD may be used by the MUP-PE 112 to resolve the ST1 route to provide UE reachabilities through whichever of the MUP-GWs 110a, 110b is in the active path (best path or backup path upon link failure).

The methods of FIGS. 2, 3, and 4 have focused on link protection with respect to the link between the MUP-GW 110a and the gNodeB 108. If the MUP-GW 110a itself failed, link protection is not sufficient. In some implementations, node protection is achieved by MUP-PE 112 installing a backup path. For example, the MUP-GW 110a may be in the primary path to gNodeB 108 and MUP-GW 110b is the backup path to gNodeB 108. Failure of MUP-GW 110a may be detected using interior gateway protocol (IGP) or bidirectional forwarding detection (BFD). The MUP-PE 112 may switch to the backup path when the MUP-PE 112 detect that MUP-GW 110a is no longer reachable.

Node protection as described above is also applicable when the MUP-GWs 110a, 110b operate in an ECMP setup, which may be configured to quickly (e.g., in less than 50 ms) purge an unfeasible path including the failed node (e.g., whichever of MUP-GW 110a, 110b failed).

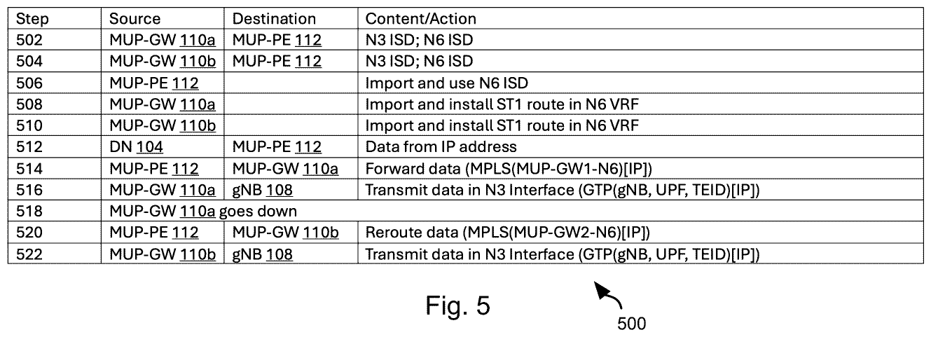

FIG. 5 illustrates a method 500 for implementing node protection. In the example of FIG. 5, MPLS is used in the access network 106. However, SRv6 may be used in a like manner.

At step 502, MUP-GW 110a originates an N3 ISD, which may be received by the MUP-PE 112. Step 502 may further include originating an N6 SID, which may be received by the MUP-PE 112. At step 504, MUP-GW 110b originates an N3 ISD, which may be received by the MUP-PE 112. Step 504 may further include originating an N6 SID, which may be received by the MUP-PE 112. At step 506, the MUP-PE 112 may import and use the N6 ISD routes. At step 508, the MUP-GW 110a imports and installs the ST1 route in the N6 VRF. At step 510, the MUP-GW 110b imports and installs the ST1 route in the N6 VRF.

There are two paths available through the two MUP-GWs 110a, 110b for downstream traffic from the data network 104 to reach the UE 102. The MUP-GW 110a is the primary exit from the access network 106. The MUP-GWs 110a, 110b may remain in an active standby setup, such as a non-ECMP active standby setup.

At step 512, an endpoint in the data network 104 may transmit data to the UE 102, e.g., an IP address of the UE 102. The data is received by the MUP-PE 112. At step 514, the MUP-PE 112 forwards the data to the MUP-GW 110a in the N6 VRF, the data being labeled with an MPLS label, e.g., MUP-GW1-N6. At step 516, MUP-GW 110a transmits the data in the N3 interface to the gNodeB 108. The data may be encapsulated into a GTP packet including the address of the gNodeB 108 (“gNB”), a UPF identifier, and tunnel endpoint identifier (TEID), as well as the IP address of the UE 102.

Steps 512-516 may be performed repeatedly during duration of communication between the UE 102 and the endpoint in the data network 104. At some point (step 518), the MUP-GW 110a goes down. Subsequent steps of the method 500 may be performed in response to failure of the MUP-GW 110a.

At step 520, the MUP-PE 112 may reroute data received at an iteration of step 512 over the N6 interface to MUP-GW 110b. Rerouting the data may include labeling the data with an MPLS label, e.g., MUP-GW2-N6 [IP], where GW2 refers to the MUP-GW 110b and IP is the IP address of the UE 102. At step 522, MUP-GW 110b transmits the data in the N3 interface to the gNodeB 108. The data may be encapsulated into a GTP packet including the address of the gNodeB 108 (“gNB”), a UPF identifier, and tunnel endpoint identifier (TEID), as well as the IP address of the UE 102.

FIG. 5 is exemplary only. The originating, importing, and/or installation of routes (steps 502-510) may be performed according to the approach of any of FIGS. 2, 3, and 4. Likewise, the forwarding of step 514 and the rerouting of step 520 may include labeling forwarded data with an SRv6 SID according to the approaches described above with respect to FIGS. 3 and 4.

In some scenarios, a double link failure may occur due to failure of the links between both MUP-GWs 110a, 110b and the gNodeB 108. Measures may therefore be taken to avoid the case of the MUP-GWs 110a, 110b sending packets to one another in a loop until the time-to-live (TTL) of the packet expires, which wastes bandwidth. For example, the ISD may carry two labels (e.g., MPLS labels) or two SIDs, one for the best path and one for the backup path. The routing behavior associated with the two labels or two SIDs may result in a packet received using the backup path not being looped back.

The approaches described above focus on processing of downstream traffic based on states of the MUP-GWs 110a, 110b. The approaches for BGP MUP PIC described herein may also be applied to upstream traffic routed from the UE 102 to the data network. For example, the data network 104 may be multi-homed with respect to multiple MUP-PE 112. In a remote DSD case, each peer MUP-PE 112 advertises its DSD to the other MUP-PE 112 having the same MUP-Extcomm. A local MUP-PE 112 uses a peer MUP-PE's 112 DSD with the same MUP-Extcomm as backup in the event of failure of a connection of the local MUP-PE 112 to the data network 104. In the local DSD case, L3VPN PIC may be relied upon to handle link failure.

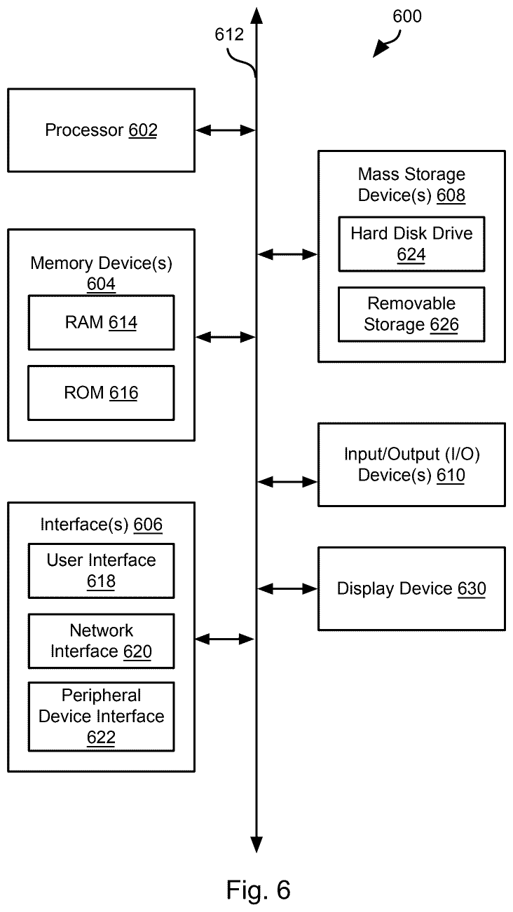

FIG. 6 is a block diagram illustrating an example computing device 600 which can be used to implement the system and methods disclosed herein, such as any of the UE 102, gNodeB 108, MUP-GW 110a, 110b, MUP-PE 112, or an endpoint in the data network 104. Computing device 600 can function as a server, a client, or any other computing entity. Computing device can perform various functions as discussed herein, and can execute one or more application programs, such as the application programs described herein. Computing device 600 can be any of a wide variety of computing devices, such as a desktop computer, a notebook computer, a server computer, a handheld computer, tablet computer and the like.

Computing device 600 includes one or more processor(s) 602, one or more memory device(s) 604, one or more interface(s) 606, one or more mass storage device(s) 608, one or more Input/Output (I/O) device(s) 610, and a display device 630 all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM) 614) and/or nonvolatile memory (e.g., read-only memory (ROM) 616). Memory device(s) 604 may also include rewritable ROM, such as Flash memory.

Mass storage device(s) 608 include various computer readable media, such as magnetic tapes, magnetic disks, optical disks, solid-state memory (e.g., Flash memory), and so forth. As shown in FIG. 6, a particular mass storage device is a hard disk drive 624. Various drives may also be included in mass storage device(s) 608 to enable reading from and/or writing to the various computer readable media. Mass storage device(s) 608 include removable media 626 and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Display device 630 includes any type of device capable of displaying information to one or more users of computing device 600. Examples of display device 630 include a monitor, display terminal, video projection device, and the like.

Interface(s) 606 include various interfaces that allow computing device 600 to interact with other systems, devices, or computing environments. Example interface(s) 606 include any number of different network interfaces 620, such as interfaces to local area networks (LANs), wide area networks (WANs), wireless networks, and the Internet. Other interface(s) include user interface 618 and peripheral device interface 622. The interface(s) 606 may also include one or more user interface elements 618. The interface(s) 606 may also include one or more peripheral interfaces such as interfaces for printers, pointing devices (mice, track pad, etc.), keyboards, and the like.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

1. A system comprising:
a first mobile user plane (MUP) gateway (MUP-GW) and a second MUP-GW;
a gNodeB that is dual-homed with respect to the first MUP-GW and the second MUP-GW and having a wireless connection to user equipment (UE);
a MUP provider edge (MUP-PE) connected to a data network; and
an access network, the first MUP-GW, the second MUP-GW, and the MUP-PE being connected to the access network;
wherein the first MUP-GW is configured to route traffic received from the MUP-PE to the second MUP-GW in response to link failure with respect to the gNodeB.

2. The system of claim 1, wherein:
the gNodeB, first MUP-GW, and second MUP-GW are all on an N3 interface; and
the first MUP-GW is configured to determine a backup path to the second MUP-GW by resolving a type 1 session transformed route (ST1) with a N3 internetwork segment discovery (ISD) route of the second MUP-GW.

3. The system of claim 1, wherein:
the gNodeB, first MUP-GW, and second MUP-GW are all on an N3 interface; and
the first MUP-GW is configured to determine a backup path to the second MUP-GW by detecting that a N3 internetwork segment discovery (ISD) route of the second MUP-GW references the address of the gNodeB.

4. The system of claim 1, wherein:
the first MUP-GW is configured to originate a first N6 internetwork segment discovery (ISD) route SD with a first MPLS label;
the second MUP-GW configured to originate a second N6 ISD route with a second MPLS label, the first MUP-GW, second MUP-GW, and MUP-PE being on a N6 interface;
the MUP-PE is configured to import the first N6 ISD route and the second N6 ISD route; and
the first MUP-GW is configured to reroute the traffic to the second MUP-GW using the second MPLS label.

5. The system of claim 4, wherein both of the first MUP-GW and second MUP-GW configured to import a type 1 session transformed (ST1) route.

6. The system of claim 1, wherein:
the first MUP-GW is configured to originate a first N3 internetwork segment discovery (ISD) route with a first general packet radio service (GPRS) tunneling protocol (GTP) encapsulation (GTP.E) segment identifier (SID);
the second MUP-GW configured to originate a second N3 ISD route with a second GTP.E SID; and
the first MUP-GW is configured to reroute the traffic to the second MUP-GW using the second GTP.E SID.

7. The system of claim 6, wherein both of the first MUP-GW and second MUP-GW configured refrain from importing a type 1 session transformed (ST1) routes.

8. The system of claim 6, wherein:
the first MUP-GW is configured to originate a first N6 internetwork segment discovery (ISD) route with a first direct transmission with table lookup and direct transmission without a table lookup (DT/DX) SID; and
the second MUP-GW configured to originate a second N6 ISD route with a second DT/DX SID.

9. The system of claim 8, wherein the MUP-PE is configured to import the first N6 ISD route and the second N6 ISD route, the first MUP-GW, second MUP-GW, and MUP-PE being on a N6 interface.

10. The system of claim 8, wherein the first MUP-GW is configured to import the second N6 ISD route and the second MUP-GW is configured to import the first N6 ISD route.

11. The system of claim 10, wherein the first MUP-GW is configured to use the second N6 ISD to route the traffic to the second MUP-GW.

12. The system of claim 11, wherein the first MUP-GW is configured to use the second N6 ISD as a backup path by resolving the second N6 ISD with a type 1 session transformed (ST1) route from the first MUP-GW.

13. The system of claim 6, wherein both of the first MUP-GW and second MUP-GW configured to import a type 1 session transformed (ST1) route.

14. A method comprising:
configuring a gNodeB to be dual-homed with respect to a first mobile user plane (MUP) gateway (MUP-GW) and a second MUP-GW and having a wireless connection to user equipment (UE);
receiving, by a MUP provider edge (MUP-PE), traffic from a data network, the traffic addressed to the UE;
forwarding, by the MUP-PE, the traffic over an access network to the first MUP-GW;
detecting, by the first MUP-GW, failure of a link to the gNodeB;
in response to detecting failure of the link to the gNodeB, routing, by the first MUP-GW, the traffic to the second MUP-GW according to border gateway protocol (BGP) prefix-independent convergence (PIC); and
forwarding, by the second MUP-GW, the traffic to the gNodeB.

15. The method of claim 14, wherein:
the gNodeB, first MUP-GW, and second MUP-GW are all on an N3 interface; and
the method further comprises, determining, by the first MUP-GW, a backup path to the second MUP-GW by resolving a type 1 session transformed route (ST1) with an internetwork segment discovery (ISD) route of the second MUP-GW.

16. The method of claim 14, wherein:
the gNodeB, first MUP-GW, and second MUP-GW are all on an N3 interface; and
the method further comprises determining, by the first MUP-GW, a backup path to the second MUP-GW by detecting that a N3 internetwork segment discovery (ISD) route of the second MUP-GW references the address of the gNodeB.

17. The method of claim 14, further comprising:
importing, by the first MUP-GW and the second MUP-GW, a type 1 session transformed (ST1) route;
originating, by the first MUP-GW, a first N6 internetwork segment discovery (ISD) route with a first MPLS label;
originating, by the second MUP-GW, a second N6 ISD route with a second MPLs label;
importing, by the MUP-PE, the first N6 ISD route and the second N6 ISD route, the first MUP-GW, second MUP-GW, and MUP-PE being on a N6 interface; and
rerouting, by the first MUP-GW, the traffic to the second MUP-GW using the second MPLS label.

18. The method of claim 14, further comprising:
originating, by the first MUP-GW, a first N3 internetwork segment discovery (ISD) route with a first general packet radio service (GPRS) tunneling protocol (GTP) encapsulation (GTP.E) segment identifier (SID);
originating, by the second MUP-GW, a second N3 ISD route with a second GTP.E SID; and
rerouting, by the first MUP-GW, the traffic to the second MUP-GW using the second GTP.E SID.

19. The method of claim 18, wherein:
originating, by the first MUP-GW, a first N6 internetwork segment discovery (ISD) route with a first direct transmission with table lookup and direct transmission without a table lookup (DT/DX) SID;
originating, by the second MUP-GW a second N6 ISD route with a second DT/DX SID; and
importing, by the MUP-PE, the first N6 ISD route and the second N6 ISD route, the first MUP-GW, second MUP-GW, and MUP-PE being on a N6 interface.

20. The method of claim 19, further comprising:
importing, by the first MUP-GW, the second N6 ISD route;
importing, by the second MUP-GW, the first N6 ISD route; and
using, by the first MUP-GW, the second N6 ISD to route the traffic to the second MUP-GW as a backup path.
